(19) United States
(12) Patent Application Publication
(10) Pub. No.: US 2011/0026264 A1
(43) Pub. Date: Feb. 3, 2011

(54) ELECTRICALLY ISOLATED HEAT SINK FOR SOLID-STATE LIGHT

(76) Inventors: William G. Reed, Seattle, WA (US); John O. Renn, Lake Forest Park, WA (US)

Correspondence Address: SEED INTELLECTUAL PROPERTY LAW GROUP PLLC, 701 FIFTH AVE, SUITE 5400, SEATTLE, WA, 98104, US

(21) Appl. No.: 12/846,516

(22) Filed: Jul. 29, 2010

Related U.S. Application Data
(60) Provisional application No. 61/229,435, filed on Jul. 29, 2009.

(51) Int. Cl. F21V 29/00; H01J 9/00

(52) U.S. Cl. 362/373; 313/46; 445/23

(57) ABSTRACT

An illumination device comprises a solid-state light source and a heat transfer structure. The solid-state light source is thermally conductively coupled to the heat transfer structure to dissipate heat thereby. The heat transfer structure includes a first thermally conductive element and a second thermally conductive element. The first thermally conductive element is configured to transfer at least a portion of the heat from the light source to an external ambient environment. The second thermally conductive element is electrically non-conductive and electrically isolates the first thermally conductive element from the light source.

### CROSS REFERENCE TO RELATED APPLICATIONS

This application claims benefit under 35 U.S.C. 119(e) to U.S. provisional patent application Ser. No. 61/229,435 filed Jul. 29, 2009 which is incorporated herein by reference in its entirety.

### BACKGROUND

1. Technical Field

This disclosure generally relates to illumination devices and, more particularly, to a heat sink in an illumination device that employs a solid-state light source such as light-emitting diodes.

2. Description of the Related Art

With increasing trend of energy conservation and for various other reasons, solid-state lighting has become more and more popular as the source of illumination in a wide range of applications. As generally known, solid-state lighting refers to a type of lighting that emits light from a solid-state materials, such as a block of semiconductor material. Such contrasts with more traditional forms of lighting, for example incandescent or fluorescent lighting which typically employ a filament in a vacuum tube or an electric discharge in a gas filled tube. Examples of solid-state lighting include light-emitting diodes (LEDs), organic light-emitting diodes (OLEDs), and polymer light-emitting diodes (PLEDs). Solid-state lighting tends to have increased lifespan compared to traditional lighting. This is because solid-state lighting provides for greater resistance to shock, vibration, and wear due to its solid-state nature. Solid-state lighting generates visible light with reduced parasitic energy dissipation in the form of reduced heat generation as compared to traditional lighting. Nevertheless, solid-state lighting does generate heat and excess heat needs to be removed from the LEDs in order to protect the LEDs from damage caused by high temperature.

Heat sinks have been used in illumination devices to remove heat from the light source. Traditional heat sinks are typically made of materials with high thermal conductivity, for example metals such as aluminum and copper. As these materials also have high electrical conductivity, electrically isolated power converters must be used to power the LEDs. However, this presents several issues. Firstly, isolated power converters are typically more expensive and difficult to manufacture than non-isolated power converters. Secondly, each finished assembly of an illumination device with an isolated power converter has to go through a set of high electrical potential tests to ensure user safety. This results in higher manufacturing costs and longer time to market. Thirdly, there is a risk that electrically conductive heat sinks can conduct electrostatic or other high-voltage transients into the LEDs or other circuitry of the illumination device, which may cause damage. While transient suppression circuitry may be added to protect the device, such adds to the cost and complexity of the resulting product.

One approach to address the above issues is to use heat sinks that are electrically non-conductive. Electrically non-conductive heat sinks are typically made of an electrically non-conductive polymer loaded with electrically non-conductive particles such as boron nitride or other ceramic materials. However, electrically non-conductive heat sinks tend to have very low thermal conductivity relative to metallic heat sinks that are electrically conductive. Further, electrically non-conductive heat sinks are typically more expensive than metallic heat sinks.

### BRIEF SUMMARY

An illumination device may be summarized as including a solid-state light source that emits light and heat when powered; and a passive heat transfer structure to which the solid-state light source is thermally conductively coupled to dissipate a least some of the heat emitted by the solid-state light source, the passive heat transfer structure including: a heat exchanger that is thermally conductive and electrically conductive, the heat exchanger having a plurality of protrusions that extend into an external ambient environment that surrounds at least a portion of an exterior of the illumination device when the illumination device is in use, the heat exchanger configured to transfer at least a portion of the heat from the solid-state light source to the external ambient environment by convective and radiant heat transfer, and an intermediate dielectric heat spreader that is thermally conductive and electrically non-conductive, the intermediate dielectric heat spreader having an area greater than an area of the solid-state light source and a periphery that encompasses the area of the intermediate dielectric heat spreader, the intermediate dielectric heat spreader positioned between the solid-state light source and the heat exchanger with a periphery of the solid-state light source encompassed by the periphery of the intermediate dielectric heat spreader such that the intermediate dielectric heat spreader thermally conductively couples the solid-state light source to the heat exchanger and electrically isolates the heat exchanger from the solid-state light source and provides arc over protection between the solid-state light source and the heat exchanger.

The intermediate dielectric heat spreader may be made of a filled polymer material. The heat exchanger may be made of a filled polymer material. At least one of the heat exchanger or the intermediate dielectric heat spreader may be a filled polymer overmold of the other one of the heat exchanger or intermediate dielectric heat spreader. The heat exchanger may have a cavity, and the intermediate dielectric heat spreader may be received in the cavity of the heat exchanger. The illumination device may further include a primary heat spreader that is thermally conductive and electrically conductive, the primary heat spreader having an area greater than the area of the solid-state light source and smaller than an area of the intermediate dielectric heat spreader, the primary heat spreader having a periphery that encompasses the area of the primary heat spreader, the primary heat spreader positioned between the solid-state light source and the intermediate dielectric heat spreader to thermally conductively couple the solid-state light source to the heat exchanger via the intermediate dielectric heat spreader. The primary heat spreader may be a vapor phase heat spreader having at least one channel that carries a heat exchange fluid which undergoes a phase change between a liquid and a vapor as the heat exchange fluid traverses the at least one channel between a relatively warmer portion and a relatively cooler portion of the primary heat spreader. The primary heat spreader may be a metallic or other high thermal conductivity plate. The intermediate dielectric heat spreader and the heat exchanger may each be made of respective filled polymer materials. The intermediate dielectric heat spreader may be a filled polymer overmold of the primary heat spreader. The heat exchanger may be a filled polymer overmold of the intermediate dielectric heat spreader. The heat exchanger may have a thermal conductivity of at least 20 Watt per meter Kelvin (W/mK), the intermediate dielectric heat spreader may have a thermal conductivity of at least 10 W/mK, and the primary heat spreader may have a thermal conductivity of at least 150 W/mK. The solid-state light source may include a plurality of light-emitting diodes (LEDs) bonded to the primary heat spreader by at least one of a metal alloy bond, a thermally conductive adhesive, or a solder bump, the illumination device does not employ any active heat transfer mechanisms, and further comprising: an electronic ballast coupled to provide regulated electrical power to the solid-state light source; a housing having a cavity to receive the electronic ballast therein, the housing physically coupled to the heat exchanger to enclose the electronic ballast between the housing and the heat exchanger; and a substantially transparent cover physically coupled to the heat exchanger to provide environmental protection to the solid-state light source.

A method of producing an illumination device may be summarized as including producing a passive heat transfer structure by: providing a heat exchanger that is thermally conductive and electrically conductive, the heat exchanger having a plurality of protrusions that extend into an external ambient environment that surrounds at least a portion of an exterior of the illumination device when the illumination device is in use, the heat exchanger configured to transfer at least a portion of the heat from the solid-state light source to the external ambient environment by convective and radiant heat transfer, and thermally coupling an intermediate dielectric heat spreader that is thermally conductive and electrically non-conductive to the heat exchanger, the intermediate dielectric heat spreader having an area greater than an area of the solid-state light source and a periphery that encompasses the area of the intermediate dielectric heat spreader; thermally conductively coupling the solid-state light source to the passive heat transfer structure with the intermediate dielectric heat spreader positioned between the solid-state light source and the heat exchanger, a periphery of the solid-state light source encompassed by the periphery of the intermediate dielectric heat spreader such that the intermediate dielectric heat spreader thermally conductively couples the solid-state light source to the heat exchanger and electrically isolates the heat exchanger from the solid-state light source and provides arc over protection between the solid-state light source and the heat exchanger.

Providing a heat exchanger may include providing a heat exchanger made of a filled polymer material, and wherein thermally conductively coupling an intermediate dielectric heat spreader to the heat exchanger may include thermally conductively coupling an intermediate dielectric heat spreader made of a filled polymer material. Thermally conductively coupling an intermediate dielectric heat spreader to the heat exchanger may include overmolding the heat exchanger on at least a portion of the intermediate dielectric heat spreader. The heat exchanger may have a cavity, and overmolding the heat exchanger on at least a portion of the intermediate dielectric heat spreader may include overmolding the heat exchanger with the intermediate dielectric heat spreader received in the cavity of the heat exchanger. The method may further include thermally coupling a primary heat spreader that is thermally conductive and electrically conductive to the intermediate dielectric heat spreader with the primary heat spreader positioned between the solid-state light source and the intermediate dielectric heat spreader, the primary heat spreader having an area greater than the area of the solid-state light source and smaller than an area of the intermediate dielectric heat spreader, and the primary heat spreader having a periphery that encompasses the area of the primary heat spreader. Thermally coupling a primary heat spreader to the intermediate dielectric heat spreader may include thermally coupling a vapor phase heat spreader to the intermediate dielectric heat spreader, the vapor phase heat spreader having at least one channel that carries a heat exchange fluid which undergoes a phase change between a liquid and a vapor as the heat exchange fluid traverses the at least one channel between a relatively warmer portion and a relatively cooler portion of the primary heat spreader. Thermally coupling a primary heat spreader to the intermediate dielectric heat spreader may include overmolding the intermediate dielectric heat spreader to at least a portion of the primary heat spreader. The intermediate dielectric heat spreader may have a cavity, and overmolding the intermediate dielectric heat spreader to at least a portion of the primary heat spreader may include overmolding the intermediate dielectric heat spreader with the primary heat spreader received in the cavity of the intermediate dielectric heat spreader.

### BRIEF DESCRIPTION OF THE SEVERAL VIEWS OF THE DRAWINGS

In the drawings, identical reference numbers identify similar elements or acts. Further, the particular shapes of the elements as drawn, are not intended to convey any information regarding the actual shape of the particular elements, and have been solely selected for ease of recognition in the drawings.

FIG. 1 is an exploded cross-sectional view of a heat transfer structure of an illumination device according to one non-limiting illustrated embodiment.

FIG. 2 is a cross-sectional view of the heat transfer structure of FIG. 1 assembled and with a light source attached thereto according to one non-limiting illustrated embodiment.

FIG. 3 is a cross-sectional view of an illumination device employing the heat transfer structure and light source of FIG. 2 according to one non-limiting illustrated embodiment.

FIG. 4 is an exploded isometric view of the illumination device of FIG. 3, showing major components of the illumination device according to one non-limiting illustrated embodiment.

FIG. 5 is an isometric diagram showing the illumination device of FIG. 4 as assembled according to one non-limiting illustrated embodiment.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with lighting fixtures, power supplies and/or power system for lighting have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Further more, the particular features, structures, or characteristics may be combined in any suitable manner in one or more embodiments.

The headings and Abstract of the Disclosure provided herein are for convenience only and do not interpret the scope or meaning of the embodiments.

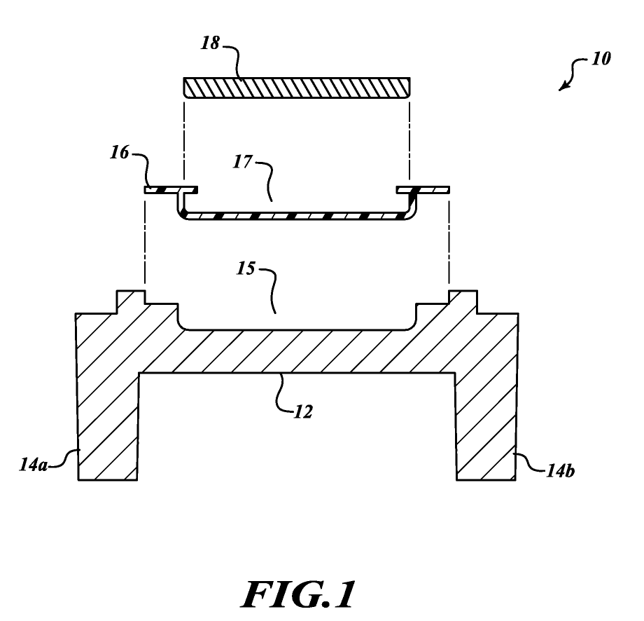

FIG. 1 shows a passive heat transfer structure 10 for use with an illumination device according to one non-limiting illustrated embodiment.

The passive heat transfer structure 10 includes a first thermally conductive element 12 interchangeable referred to herein and in the claims as a heat exchanger, a second thermally conductive element 16 interchangeable referred to herein and in the claims as an intermediate dielectric heat spreader, and a third thermally conductive element 18 interchangeable referred to herein and in the claims as a primary heat spreader. In an alternative embodiment, the passive heat transfer structure 10 includes the first thermally conductive element or heat exchanger 12 and the second thermally conductive element or intermediate dielectric heat spreader 16, but omits the third thermally conductive element or primary heat spreader 18. Each of the thermally conductive elements 12, 16, 18 has a respective first primary side, a respective second primary side opposite the respective first primary side, and at least one peripheral surface between the first and the second primary surfaces. For example, a thermally conductive element 12, 16, 18 in the general shape of a rectangular prism has two primary sides and a periphery with at least four peripheral surfaces between the first and the second primary sides. A thermally conductive element 12, 16, 18 in the general shape of a disc or cylinder, has two primary sides and one continuous peripheral surface between the first and the second primary sides without edges or discontinuities in the radius of curvature.

The first primary side of the third thermally conductive element or primary heat spreader 18 is configured for a solid-state light source to be attached or otherwise physically coupled to. For example, the first primary side of the third thermally conductive element or primary heat spreader 18 may have a substantially flat area or region sufficiently large to allow one or more solid-state light emitters, such as light-emitting diodes (LEDs), to be attached thereto or carried thereon, and to spread the heat generated by the solid-state light source over a larger area than an area occupied by the solid-state light source.

The first primary side of the second thermally conductive element or intermediate dielectric heat spreader 16 has a recess or cavity 17 substantially matching an exterior profile of the second primary side and the at least one peripheral surface of the third thermally conductive element or primary heat spreader 18. This allows for the third thermally conductive element or primary heat spreader 18 to be matingly, i.e., snuggly, received in the cavity 17 of the second thermally conductive element or intermediate dielectric heat spreader 16. The second thermally conductive element or intermediate dielectric heat spreader 16 may be made of a polymer with a thermally conductive filler (i.e., filled polymer material). The filled polymer material may be overmolded to the third thermally conductive element or primary heat spreader 18 to advantageously ensure intimate contact and very good conductive heat transfer. This may lower manufacturing costs as compared to when the second thermally conductive element or intermediate dielectric heat spreader 16, especially the cavity 17, is metal that is precision machined in order to achieve the desired intimate contact between the second and the third thermally conductive elements 16, 18. The second thermally conductive element or intermediate dielectric heat spreader 16 may be overmolded to the third thermally conductive element or primary heat spreader 18 such that a peripheral rim is formed around the opening of the cavity 17 to partially envelop the third thermally conductive element 18, as shown in FIG. 1. Such may enhance protection against arc over.

The first primary side of the first thermally conductive element or heat exchanger 12 may have a recess or cavity 15 substantially matching an exterior profile of the second primary side and the at least one peripheral surface of the second thermally conductive element or intermediate dielectric heat spreader 16. This allows for the second thermally conductive element 16 to be matingly received in the cavity 15 of the first thermally conductive element or heat exchanger 12. The first thermally conductive element or heat exchanger 12 may be made of a polymer with a thermally conductive filler (i.e., filled polymer material). The first thermally conductive element or heat exchanger may advantageously be overmolded to the second thermally conductive element or intermediate dielectric heat spreader 16 to ensure intimate contact and providing very good conductive heat transfer therebetween. Likewise, the associated manufacturing costs should be lower than the case when the first thermally conductive element or heat exchanger 12, especially the cavity 15, is metal that is precision machined in order to achieve the intimate contact between the first and the second thermally conductive elements 12, 16.

The first thermally conductive element or heat exchanger 12 is electrically conductive as well as thermally conductive. The first thermally conductive element or heat exchanger 12 provides a mechanism to convectively and radiantly transfer heat to an ambient environment, such as air surrounding at least part of the illumination device. The first thermally conductive element or heat exchanger 12 may, for example, be made of a type of filled polymer that is electrically and thermally conductive. Alternatively, the first thermally conductive element 12 or heat exchanger may be made of a metallic material, such as aluminum, aluminum alloy, copper, copper alloy, or other suitable material having desirable thermal conductivity.

The first thermally conductive element 12 may include protrusions 14a, 14b to maximize the surface area through which heat can be transferred from the first thermally conductive element 12 to an external ambient environment (e.g., air surrounding the exterior of the illumination device) via convection and radiation. The protrusions may, for example, be fin-shaped, such as illustrated in the Figure. Although only one pair of fin-shaped protrusions 14a, 14b is visible in FIG. 1, there are a plurality of pairs of fin-shaped protrusions 14a, 14b in other embodiments. Further, although the fin-shaped protrusions 14a, 14b are shown as having a generally rectangular shape, the fin-shaped protrusions 14a, 14b have other shapes, for example, triangular or trapezoidal shape, in other embodiments. Alternatively, other structures to increase surface area may be employed, for instance pin shaped protrusions. Such may be integral or a unitary part (e.g., die-cast, stamped, machined from) of the first thermally conductive element or heat exchanger 12 or may be added thereto (e.g., soldered, welded, press fit in apertures such as throughholes). The first thermally conductive element 12 may be made of an electrically conductive heat conductor polymer, for instance CoolPoly® E5101 from Cool Polymers, Inc., with thermal conductivity of at least 20 Watt per meter Kelvin (W/mK).

The second thermally conductive element or intermediary dielectric heat spreader 16 is substantially electrically non-conductive, or electrically insulating, and serves to spread heat over a relatively large area as compared to the source of the heat. The second thermally conductive element 16 may be made of a type of filled polymer that is electrically non-conductive but thermally conductive. The second thermally conductive element 16 may be made of a dielectric material, such as a ceramic material, or an electrically non-conductive polymer loaded with electrically non-conductive particles such as boron nitride or other ceramic materials. The second thermally conductive element or intermediary dielectric heat spreader 16 may be made of an electrically insulating heat conductor polymer, for instance CoolPoly® D5506 from Cool Polymers, Inc., with thermal conductivity of at least 10 W/mK.

As electrically non-conductive materials typically have lower heat conductivity than that of electrically conductive materials, such as aluminum or copper, the second thermally conductive element or intermediary dielectric heat spreader 16 is preferably only thick enough to provide for electrical insulation and arc-over protection for the third thermally conductive element or primary heat spreader 18. Hence, the perimeter of the second thermally conductive element 16 may extend beyond the perimeter of the first thermally conductive element 18. The second thermally conductive element or intermediary dielectric heat spreader 16 may, for example, have a thickness between the first primary side and the second primary side of approximately 0.25 mm. By including the electrically non-conductive second thermally conductive element or intermediary dielectric heat spreader 16 in the passive heat transfer structure 10, no electrical conduction can take place between one side of the passive heat transfer structure 10 toward the first thermally conductive element or heat exchanger 12 and the other side of the passive heat transfer structure 10 toward the third thermally conductive element or primary heat spreader 18. The overall heat conductivity is kept relatively high by employing a second thermally conductive element or intermediary dielectric heat spreader 16 having a minimum thickness that is sufficient to provide the desired electrical insulation.

The third thermally conductive element or primary heat spreader 18 is electrically conductive and serves to spread heat over a larger area than the source of the heat. The third thermally conductive element or primary heat spreader 18 may be a solid piece of metallic plate, such as a copper plate. Alternatively, the third thermally conductive element or primary heat spreader 18 may be a piece of graphite, for instance a solid piece of graphite. Preferably, the third thermally conductive element or primary heat spreader 18 is a vapor phase type heat spreader. The vapor phase heat spreader includes a housing or container made of a metallic material with one or more channels that contains a fluid that transitions between a liquid phase and a gaseous phase. The vaporization and condensation of the fluid provide the mechanism to transport heat from one primary side (the hotter interface) to the other primary side (the colder interface) of the container as the fluid transits the channel(s). At the hotter interface, proximate the solid-state light source, the fluid contained in the channel(s) vaporizes as heat generated by the solid-state light source is absorbed by the container and fluid. The vapor travels to the colder interface of the container and condenses into liquid, thus releasing heat to the second thermally conductive element or intermediate dielectric heat spreader 16. The liquid then flows back to the hotter interface of the container, and the heat transfer cycle repeats. The third thermally conductive element or primary heat spreader 18 may be an IVC heat spreader from PyroS Corporation, with thermal conductivity of at least 10,000 W/mK. Alternatively, the third thermally conductive element or primary heat spreader 18 may be made of specialized graphite with a thermal conductivity of at least 1,200 W/mK.

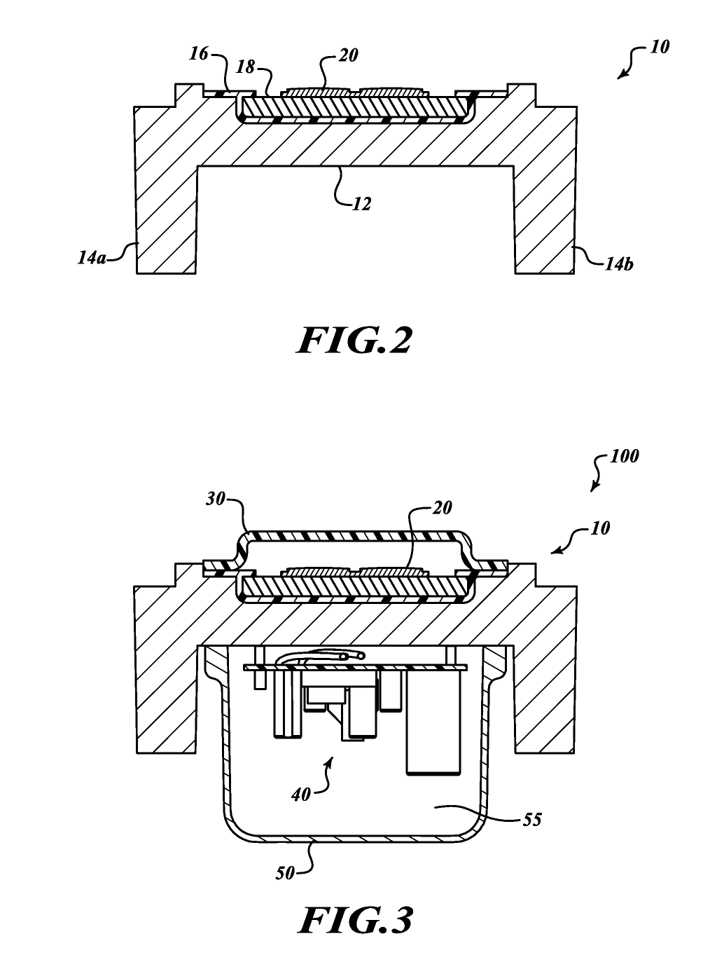

FIG. 2 shows the passive heat transfer structure 10 with a solid-state light source 20 attached thereto according to one non-limiting illustrated embodiment.

The solid-state light source 20 is attached or otherwise physically coupled to the third thermally conductive element or primary heat spreader 18 of the passive heat transfer structure 10. In one embodiment, the light source 20 is bonded to the third thermally conductive element 18. The bonding may be accomplished, for example, by one or any combination of the following methods: metal alloy bonding, thermally conductive adhesives, and soldering.

The solid-state light source 20 includes one or more solid-state light emitters, for instance LEDs, OLEDs, or PLEDs. The solid-state light source 20 emits light when electrical power is provided. When the solid-state light source 20 emits light, the solid-state light source 20 also generates waste heat. As high temperature tends to degrade and reduce the lifetime of a solid-state light emitter, the heat generated by the solid-state light source 20 needs to be removed from the solid-state light source 20.

With the solid-state light source 20 attached to the third thermally conductive element or primary heat spreader 18, at least a portion of the heat generated by the solid-state light source 20 is transferred to the third thermally conductive element or primary heat spreader 18 by conduction and radiation. More specifically, a portion of the heat from the solid-state light source 20 is transferred to the third thermally conductive element or primary heat spreader 18 by conduction through a relatively small area on the hotter interface of the third thermally conductive element or primary heat spreader 18 where the solid-state light source 20 is bonded. The heat thus absorbed by the third thermally conductive element or primary heat spreader 18 is then spread to the colder interface of the third thermally conductive element or primary heat spreader 18 due to the temperature gradient between the hotter and colder interfaces. At least a portion of the heat absorbed by the third thermally conductive element or primary heat spreader 18 from the solid-state light source 20 is transferred by conduction to the second thermally conductive element or intermediate dielectric heat spreader 16, which in turn transfers at least a portion such heat to the first thermally conductive element or heat exchanger 12 by thermal conduction. The first thermally conductive element or heat exchanger 12 then dissipates the absorbed heat to the external ambient environment (e.g., air surrounding the illumination device or heat transfer structure) directly and via the fin-shaped protrusions 14a, 14b by convection and radiation.

In one embodiment, the passive heat transfer structure 10 includes the electrically conductive first thermally conductive element or heat exchanger 12 and the electrically non-conductive second thermally conductive element or intermediate dielectric heat spreader 16, but not the third thermally conductive element or primary heat spreader 18. In such case, the solid-state light source 20 is attached or otherwise physically and thermally coupled directly to the second thermally conductive element or intermediate dielectric heat spreader 16.

FIG. 3 shows an illumination device 100 according to one non-limiting illustrated embodiment.

The illumination device 100 includes the passive heat transfer structure 10, the solid-state light source 20, a substantially transparent or translucent optical cover plate 30, an electronic ballast 40, and a housing 50. As shown in FIG. 2, the solid-state light source 20 is attached to the third thermally conductive element or primary heat spreader 18 of the passive heat transfer structure 10.

The optical cover plate 30 is mounted to the passive heat transfer structure 10 to enclose the solid-state light source 20 between the optical cover plate 30 and the passive heat transfer structure 10. In one embodiment, the optical cover plate 30 is mounted to the passive heat transfer structure 10 by mechanical structures such as fasteners (e.g., screws, bolts, rivets, clips, snaps, tabs) or adhesives. The optical cover plate 30 may act as a weather seal to exclude moisture and other contamination elements from the solid-state light source 20. Alternatively, a weather seal may be provided between the optical cover plate 30 and the passive heat transfer structure 10. In one embodiment, the optical cover plate 30 is configured (e.g., shaped to form lenses and/or reflectors) to direct light emitted by the solid-state light source 20 into an acceptable or desired illumination pattern at a ground level. For example, the illumination pattern is a NEMA designated “butterfly” pattern that evenly distributes the light emitted by the light source 20 over a large area on the ground.

The electronic ballast 40 may be coupled to receive AC power, such as from AC power mains. The electronic ballast 40 regulates the received AC power to provide the regulated power to the solid-state light source 20. Alternatively, the electronic ballast 40 includes electronics to receive DC power, such as from one or more batteries, to provide to the solid-state light source 20. The electronic ballast 40 may, for example, be configured to receive power from a photovoltaic power source, a wind power source, or another alternative energy source. Wirings for the electronic ballast 40 to receive power and wirings between the electronic ballast 40 and the solid-state light source 20 are not shown in order to avoid obscuring the illustrated embodiments. The electronic ballast 40 may be mounted to the first thermally conductive element or primary heat spreader 12 of the passive heat transfer structure 10, for example by mechanical structures such as fasteners (e.g., screws, bolts, rivets, clips, snaps, tabs) or adhesives. In such case, heat generated by the electronic ballast 40 is transferred to the passive heat transfer structure 10 to be dissipated by at least one of conduction, convection, and/or radiation. Alternatively, the electronic ballast 40 may be mounted to the housing 50, and heat generated by the electronic ballast 40 is transferred to the housing 50 to be dissipated by at least one of conduction, convection, and radiation.

The housing 50 may have a cavity 55 that is appropriately sized to receive and house the electronic ballast 40. The housing 50 may be attached or otherwise physically coupled to the first thermally conductive element or heat exchanger 12 of the passive heat transfer device 10 to enclose the electronic ballast 40 between the housing 50 and the first thermally conductive element or heat exchanger 12. The housing 50 may be mounted to the first thermally conductive element or heat exchanger 12 by mechanical structures such as fasteners (e.g., screws, bolts, rivets, clips, snaps, tabs) or adhesives. As heat generated by the enclosed electronic ballast 40 needs to be dissipated regardless of the location where the electronic ballast 40 is mounted, the housing 50 may be made of a material of suitable thermal conductivity, such as metal, to promote heat dissipation. For example, even when the electronic ballast 40 is mounted to the first thermally conductive element or heat exchanger 12 of the passive heat transfer device 10, at least a portion of the heat generated by the electronic ballast 40 will still likely be transferred to the housing 50 by convection and radiation. The housing 50 will, in turn, dissipate such heat to the external ambient environment via convective or radiant heat transfer mechanisms.

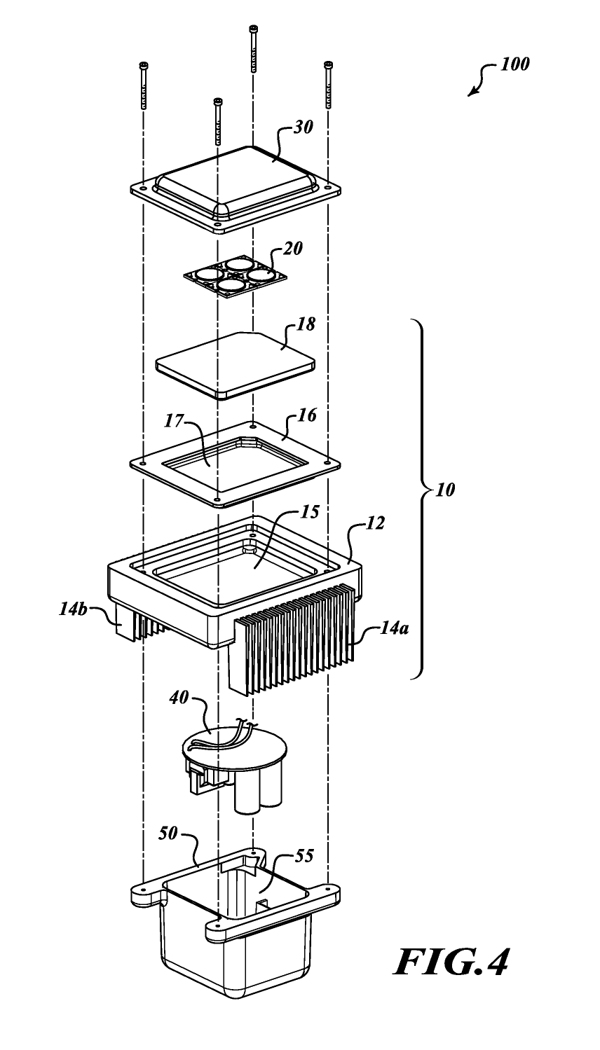

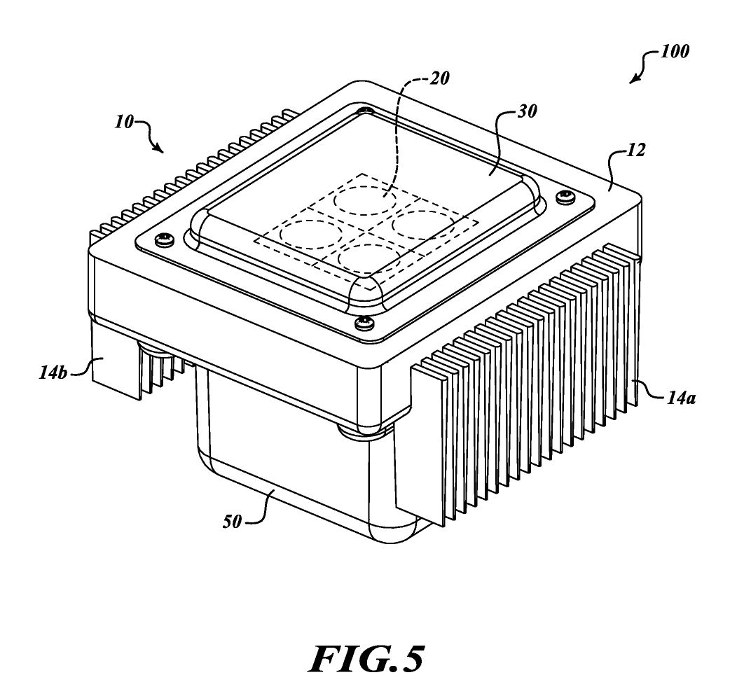

FIGS. 4 and 5 show the illumination device 100 according to one non-limiting illustrated embodiment.

As best shown in FIG. 4, the first thermally conductive element or heat exchanger 12 includes a plurality of pairs of protrusions, for instance fin-shaped protrusions 14a, 14b along its two peripheral surfaces which extend into the ambient environment when the illumination device 100 is in use to promote heat dissipation. Although the solid-state light source 20 includes four LEDs as shown in FIG. 4, in other embodiments the solid-state light source 20 includes fewer or more LEDs.

It will be understood that the illumination device 100 shown in FIGS. 4 and 5 is for illustrative purpose only, and that different embodiments of the illumination device 100 have different sizes and shapes. For example, each of the thermally conductive elements 12, 16, 18 shown in FIGS. 4 and 5 has in general at least four peripheral surfaces because the two primary sides of these components have a generally rectangular shape or profile. In an alternative embodiment, the two primary sides of the thermally conductive elements 12, 16, 18 have a generally circular shape or profile. In such case, the optical cover plate 30 accordingly has a generally circular shape or profile and the housing 50 accordingly has a generally cylindrical shape or profile.

Thus, the illumination device 100 disclosed herein should greatly improve upon the problems associated with illumination devices that use traditional heat sinks and electrically isolated power converters, and illumination devices that use electrically non-conductive heat sinks with low thermal conductivity. For example, the solid-state light source 20 is electrically isolated and thus protected from electrostatic or other high voltage transients from the power supply because of the presence of the electrically non-conductive second thermally conductive element or intermediate dielectric heat spreader 16. Further, the overall heat conductivity of the passive heat transfer device 10 is relatively high and desirable because the thickness of the second thermally conductive element or intermediate dielectric heat spreader 16 is kept at a minimum thickness that still provides sufficient electrical insulation.

As used herein and in the claims, the term “passive” means that the heat transfer structure does not consume electrical power to operate, at most using the waste heat generated by the light sources. In some embodiments, an active heat transfer device may be thermally coupled, conductively, convectively, and/or radiantly to the passive heat transfer structure. While such may advantageously increase the effective rate of cooling, such might disadvantageously consume additional electrical power, increase size, complexity and/or cost.

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in the relevant art. The teachings provided herein of the various embodiments can be applied to other context, not necessarily the exemplary context of illumination devices with solid-state light emitters generally described above.

To the extent that they are not inconsistent with the teachings herein, the teachings of U.S. patent application Ser. No. 12/437,467 filed May 7, 2009; U.S. patent application Ser. No. 12/437,472 filed May 7, 2009; U.S. provisional patent application Ser. No. 61/088,651 filed Aug. 13, 2008; U.S. provisional patent application Ser. No. 61/154,619 filed Feb. 23, 2009; U.S. provisional patent application Ser. No. 61/174,913 filed May 1, 2009; and U.S. provisional patent application Ser. No. 61/180,017 filed May 20, 2009, are each incorporated herein by reference in their entirety.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

We claim:

1. An illumination device, comprising:
a solid-state light source that emits light and heat when powered; and
a passive heat transfer structure to which the solid-state light source is thermally conductively coupled to dissipate a least some of the heat emitted by the solid-state light source, the passive heat transfer structure including:
a heat exchanger that is thermally conductive and electrically conductive, the heat exchanger having a plurality of protrusions that extend into an external ambient environment that surrounds at least a portion of an exterior of the illumination device when the illumination device is in use, the heat exchanger configured to transfer at least a portion of the heat from the solid-state light source to the external ambient environment by convective and radiant heat transfer, and
an intermediate dielectric heat spreader that is thermally conductive and electrically non-conductive, the intermediate dielectric heat spreader having an area greater than an area of the solid-state light source and a periphery that encompasses the area of the intermediate dielectric heat spreader, the intermediate dielectric heat spreader positioned between the solid-state light source and the heat exchanger with a periphery of the solid-state light source encompassed by the periphery of the intermediate dielectric heat spreader such that the intermediate dielectric heat spreader thermally conductively couples the solid-state light source to the heat exchanger and electrically isolates the heat exchanger from the solid-state light source and provides arc over protection between the solid-state light source and the heat exchanger.

2. The illumination device of claim 1 wherein the intermediate dielectric heat spreader is made of a filled polymer material.

3. The illumination device of claim 1 wherein the heat exchanger is made of a filled polymer material.

4. The illumination device of claim 1 wherein at least one of the heat exchanger or the intermediate dielectric heat spreader is a filled polymer overmold of the other one of the heat exchanger or intermediate dielectric heat spreader.

5. The illumination device of claim 1 wherein the heat exchanger has a cavity, and the intermediate dielectric heat spreader is received in the cavity of the heat exchanger.

6. The illumination device of claim 1, further comprising:
a primary heat spreader that is thermally conductive and electrically conductive, the primary heat spreader having an area greater than the area of the solid-state light source and smaller than an area of the intermediate dielectric heat spreader, the primary heat spreader having a periphery that encompasses the area of the primary heat spreader, the primary heat spreader positioned between the solid-state light source and the intermediate dielectric heat spreader to thermally conductively couple the solid-state light source to the heat exchanger via the intermediate dielectric heat spreader.

7. The illumination device of claim 6 wherein the primary heat spreader is a vapor phase heat spreader having at least one channel that carries a heat exchange fluid which undergoes a phase change between a liquid and a vapor as the heat exchange fluid traverses the at least one channel between a relatively warmer portion and a relatively cooler portion of the primary heat spreader.

8. The illumination device of claim 6 wherein the primary heat spreader is a metallic plate.

9. The illumination device of claim 6 wherein the intermediate dielectric heat spreader and the heat exchanger are each made of respective filled polymer materials.

10. The illumination device of claim 9 wherein the intermediate dielectric heat spreader is a filled polymer overmold of the primary heat spreader.

11. The illumination device of claim 10 wherein the heat exchanger is a filled polymer overmold of the intermediate dielectric heat spreader.

12. The illumination device of claim 6 wherein the heat exchanger has a thermal conductivity of at least 20 Watt per meter Kelvin (W/mK), the intermediate dielectric heat spreader has a thermal conductivity of at least 10 W/mK, and the primary heat spreader has a thermal conductivity of at least 1,200 W/mK.

13. The illumination device of claim 6 wherein the solid-state light source includes a plurality of light-emitting diodes (LEDs) bonded to the primary heat spreader by at least one of a metal alloy bond, a thermally conductive adhesive, or a solder bump, the illumination device does not employ any active heat transfer mechanisms, and further comprising:
an electronic ballast coupled to provide regulated electrical power to the solid-state light source;
a housing having a cavity to receive the electronic ballast therein, the housing physically coupled to the heat exchanger to enclose the electronic ballast between the housing and the heat exchanger; and
a substantially transparent cover physically coupled to the heat exchanger to provide environmental protection to the solid-state light source.

14. A method of producing an illumination device, the method comprising:
producing a passive heat transfer structure by:
providing a heat exchanger that is thermally conductive and electrically conductive, the heat exchanger having a plurality of protrusions that extend into an external ambient environment that surrounds at least a portion of an exterior of the illumination device when the illumination device is in use, the heat exchanger configured to transfer at least a portion of the heat from the solid-state light source to the external ambient environment by convective and radiant heat transfer, and
thermally coupling an intermediate dielectric heat spreader that is thermally conductive and electrically non-conductive to the heat exchanger, the intermediate dielectric heat spreader having an area greater than an area of the solid-state light source and a periphery that encompasses the area of the intermediate dielectric heat spreader;
thermally conductively coupling the solid-state light source to the passive heat transfer structure with the intermediate dielectric heat spreader positioned between the solid-state light source and the heat exchanger, a periphery of the solid-state light source encompassed by the periphery of the intermediate dielectric heat spreader such that the intermediate dielectric heat spreader thermally conductively couples the solid-state light source to the heat exchanger and electrically isolates the heat exchanger from the solid-state light source and provides arc over protection between the solid-state light source and the heat exchanger.

15. The method of claim 14 wherein providing a heat exchanger includes providing a heat exchanger made of a filled polymer material, and wherein thermally conductively coupling an intermediate dielectric heat spreader to the heat exchanger includes thermally conductively coupling an intermediate dielectric heat spreader made of a filled polymer material.

16. The method of claim 15 wherein thermally conductively coupling an intermediate dielectric heat spreader to the heat exchanger includes overmolding the heat exchanger on at least a portion of the intermediate dielectric heat spreader.

17. The method of claim 16 wherein the heat exchanger has a cavity, and overmolding the heat exchanger on at least a portion of the intermediate dielectric heat spreader includes overmolding the heat exchanger with the intermediate dielectric heat spreader received in the cavity of the heat exchanger.

18. The method of claim 14, further comprising:
thermally coupling a primary heat spreader that is thermally conductive and electrically conductive to the intermediate dielectric heat spreader with the primary heat spreader positioned between the solid-state light source and the intermediate dielectric heat spreader, the primary heat spreader having an area greater than the area of the solid-state light source and smaller than an area of the intermediate dielectric heat spreader, and the primary heat spreader having a periphery that encompasses the area of the primary heat spreader.

19. The method of claim 18 wherein thermally coupling a primary heat spreader to the intermediate dielectric heat spreader includes thermally coupling a vapor phase heat spreader to the intermediate dielectric heat spreader, the vapor phase heat spreader having at least one channel that carries a heat exchange fluid which undergoes a phase change between a liquid and a vapor as the heat exchange fluid traverses the at least one channel between a relatively warmer portion and a relatively cooler portion of the primary heat spreader.

20. The method of claim 18 wherein thermally coupling a primary heat spreader to the intermediate dielectric heat spreader includes overmolding the intermediate dielectric heat spreader to at least a portion of the primary heat spreader.

21. The method of claim 20 wherein the intermediate dielectric heat spreader has a cavity, and overmolding the intermediate dielectric heat spreader to at least a portion of the primary heat spreader includes overmolding the intermediate dielectric heat spreader with the primary heat spreader received in the cavity of the intermediate dielectric heat spreader.
